(19) United States
(12) Patent Application Publication
(10) Pub. No.: US 2025/0346050 A1
(43) Pub. Date: Nov. 13, 2025

(54) IMAGE FORMING APPARATUS THAT CORRECTS SKEW OF RECORDING SHEET BEING TRANSPORTED

(71) Applicant: KYOCERA Document Solutions Inc., Osaka (JP)

(72) Inventors: Katsuo MIKASHIMA, Osaka (JP); Yuichiro KUROKAWA, Osaka (JP); Daijiro UENO, Osaka (JP)

(73) Assignee: KYOCERA Document Solutions Inc., Osaka (JP)

(21) Appl. No.: 19/198,231

(22) Filed: May 5, 2025

(30) Foreign Application Priority Data
May 8, 2024 (JP) 2024-076179

(51) Int. Cl. B41J 11/00

(52) U.S. Cl. CPC B41J 11/0055; B41J 11/007; B41J 11/0095

(57) ABSTRACT

An image forming apparatus includes a skew correction mechanism having an alignment plate extending parallel to a transport direction of a recording sheet, and configured to correct a skew of the recording sheet with respect to the transport direction, by pressing a side of the recording sheet extending along the transport direction, against the alignment plate, an inclination angle adjustment mechanism that enables manual adjustment of the inclination angle of the alignment plate with respect to the transport direction, a calculator that calculates a distance between the leading edge corner and the trailing edge corner in the width direction orthogonal to the transport direction, detected by the detection device, as a deviation amount of the recording sheet, and calculates an adjustment amount of the inclination angle that reduces the deviation amount, and a controller that notifies the adjustment amount of the inclination angle calculated by the calculator, to a user.

### INCORPORATION BY REFERENCE

This application claims priority to Japanese Patent Application No.2024-076179 filed on May 8, 2024, the entire contents of which are incorporated by reference herein.

### BACKGROUND

The present disclosure relates to an image forming apparatus that prints an image on both faces of a recording sheet.

Image forming apparatuses, such as a printer capable of performing duplex printing on a recording sheet, are known. When performing the duplex printing, the printing positions on the front face and the back face of the sheet have to match with each other. This is particularly important when, for example, the printed materials are bound into a book as merchandise. Therefore, techniques to correct a shift of the recording sheet in the width direction orthogonal to the transport direction (transverse shift), and a skew with respect to the transport direction, have been developed.

### SUMMARY

The disclosure proposes further improvement of the foregoing technique.

In an aspect, the disclosure provides an image forming apparatus including an image forming device, a sheet feeding device, a reversing mechanism, a skew correction mechanism, an inclination angle adjustment mechanism, a detection device, a control device, and a notification device. The image forming device forms an image on a recording sheet. The sheet feeding device supplies the recording sheet to the image forming device. The reversing mechanism reverses a front face and a back face of the recording sheet, on which the image has been formed by the image forming device. The skew correction mechanism includes an alignment plate extending parallel to a transport direction of the recording sheet, and corrects a skew of the recording sheet with respect to the transport direction, by pressing a side of the recording sheet extending along the transport direction against the alignment plate. The inclination angle adjustment mechanism adjusts an inclination angle of the alignment plate with respect to the transport direction. The detection device detects a leading edge corner, and a trailing edge corner on a same side as the leading edge corner, in the transport direction, of the recording sheet the skew of which has been corrected by the skew correction mechanism. The control device includes a processor, and acts as a controller and a calculator, when the processor executes a control program. The controller executes duplex printing including forming an image on the front face and the back face of the recording sheet, by controlling operation of the image forming device, the sheet feeding device, and the reversing mechanism. The calculator calculates a distance between the leading edge corner and the trailing edge corner in the width direction orthogonal to the transport direction, detected by the detection device, as a deviation amount of the recording sheet, and calculates an adjustment amount of the inclination angle that reduces the deviation amount. The controller causes the notification device to notify the adjustment amount of the inclination angle, calculated by the calculator. The skew correction mechanism is located on an upstream side of the image forming device, in the transport direction.

### BRIEF DESCRIPTION OF THE DRAWINGS

FIG. 1 is a functional block diagram schematically showing an essential internal configuration of an image forming apparatus according to an embodiment of the disclosure;

FIG. 2 is a schematic front cross-sectional view showing the image forming apparatus;

FIG. 3 is a schematic plan view showing a skew correction mechanism;

FIG. 4A to FIG. 4C are plan views for explaining a process of correcting a skew of a recording sheet with respect to a transport direction, using the skew correction mechanism;

FIG. 5A to FIG. 5C are schematic plan views each showing an alignment plate and an inclination angle adjustment mechanism;

FIG. 6 is a plan view showing a location example of a contact image sensor (CIS) constituting a detection device;

FIG. 7A and FIG. 7B are schematic drawings each showing an example of a posture of the recording sheet, detected by the detection device;

FIG. 8 is a schematic plan view showing a joint mechanism connecting an apparatus main body and a sheet feeding unit;

FIG. 9A is an enlarged front view schematically showing a fulcrum device in the joint mechanism;

FIG. 9B to FIG. 9D are enlarged front views each showing a sheet angle adjustment mechanism in the joint mechanism;

FIG. 10 is a flowchart showing a process performed by the image forming apparatus, for adjusting an inclination angle of an alignment plate in the skew correction mechanism;

FIG. 11A and FIG. 11B are schematic drawings for explaining an image forming area, defined when an image is formed on the front face and the back face of the recording sheet, with the recording sheet P kept inclined; and

FIG. 12A and FIG. 12B are schematic drawings each showing the image forming area, seen from the side of the front face of the recording sheet.

### DETAILED DESCRIPTION

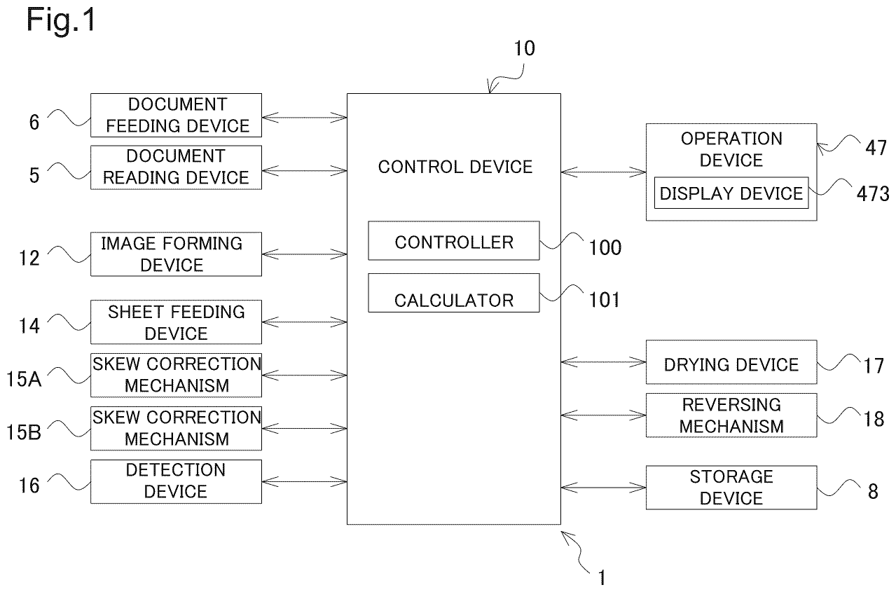

Hereafter, an image forming apparatus according to an embodiment of the disclosure will be described, with reference to the drawings. FIG. 1 is a functional block diagram schematically showing an essential internal configuration of the image forming apparatus according to the embodiment of the disclosure.

The image forming apparatus 1 is a multifunction peripheral having a plurality of functions, such as copying, printing, scanning, and facsimile transmission, and includes a control device 10, a document feeding device 6, a document reading device 5, an image forming device 12, a sheet feeding device 14, skew correction mechanisms 15A and 15B, a detection device 16, a drying device 17, a reversing mechanism 18, an operation device 47, and a storage device 8.

The document feeding device 6 is openably connected to the upper face of the document reading device 5, for example via a non-illustrated hinge, and serves as a document retention cover, when a document placed on a non-illustrated platen glass is to be read. The document feeding device 6 is what is known as an automatic document feeder (ADF), and includes a non-illustrated document tray, to supply the documents placed on the document tray one by one, to the document reading device 5.

The document reading device 5 includes a scanner, to read the document delivered from the document feeding device 6, or the document placed on the platen glass. The document reading device 5 can also sequentially read a plurality of documents delivered from the document feeding device 6.

To perform the document reading operation, the image forming apparatus 1 operates as follows. The document reading device 5 optically reads the image on the document delivered from the document feeding device 6 to the document reading device 5, or placed on the platen glass, and generates image data. The image data generated by the document reading device 5 is stored, for example, in a non-illustrated image memory.

To perform the image forming operation, the image forming apparatus 1 operates as follows. The image forming device 12 forms an image by ink jet printing, on a recording sheet delivered from the sheet feeding device 14, on the basis of the image data generated through the document reading operation, image data stored in the image memory, or image data received from a computer connected via the network. The sheet feeding device 14 accommodates therein the recording sheets, and supplies the recording sheets to the image forming device 12.

The skew correction mechanisms 15A and 15B each serve to correct a skew of the recording sheet with respect to the transport direction. The detection device 16 detects a leading edge corner, and a trailing edge corner on the same side as the leading edge corner in the transport direction, of the recording sheet the skew of which has been corrected by the skew correction mechanisms 15A and 15B.

The drying device 17 transports the recording sheet having an image formed thereon by the image forming device 12, and dries the ink stuck to the recording sheet. The reversing mechanism 18 reverses the front face and the back face of the recording sheet, on one face of which the image has been formed by the image forming device 12.

The operation device 47 includes various hard keys to be operated by the user, receives the user's instructions inputted with the hard keys, to execute the functions and operations that the image forming apparatus 1 is configured to perform, for example the image forming operation.

The operation device 47 includes a display device 473 for displaying, for example, an operation guide for the user. The operation device 47 receives, through a touch panel provided on the display device 473, the user's instruction based on the touch operation performed by the user on the screen displayed on the display device 473, or on a physical key.

The display device 473 is constituted of, for example, a liquid crystal display (LCD). When the user touches a button or a key displayed on the screen, a touch panel overlaid on the display device 473 receives the instruction corresponding to the touched position. In this case, the touch panel acts as a part of the operation device 47.

The storage device 8 is a large-capacity storage device such as a hard disk drive (HDD) or a solid-state drive (SSD), and contains various control programs.

The control device 10 includes a processor, a random-access memory (RAM), a read-only memory (ROM), and an exclusive hardware circuit. The processor is, for example, a central processing unit (CPU), an application specific integrated circuit (ASIC), or a micro processing unit (MPU). The control device 10 acts as a controller 100 and a calculator 101.

The control device 10 is configured to act as the controller 100 and the calculator 101, when the processor operates according to the control program stored in the storage device 8. Here, the controller 100 and the calculator 101 may be constituted in the form of a hardware circuit, instead of being realized by the operation of the control device 10 according to the control program. This also applies to other embodiments, unless otherwise specifically noted.

The controller 100 serves to control the overall operation of the image forming apparatus 1. The controller 100 is connected to the document feeding device 6, the document reading device 5, the image forming device 12, the sheet feeding device 14, the skew correction mechanisms 15A and 15B, the detection device 16, the drying device 17, the reversing mechanism 18, the operation device 47, and the storage device 8, and controls the operation of the cited components. For example, the controller 100 executes some processings required for the image forming operation to be performed by the image forming apparatus 1. As another example, the controller 100 controls the operation of the image forming device 12, the sheet feeding device 14, and the reversing mechanism 18, to execute a duplex printing, by forming images on the front face and the back face of the recording sheet.

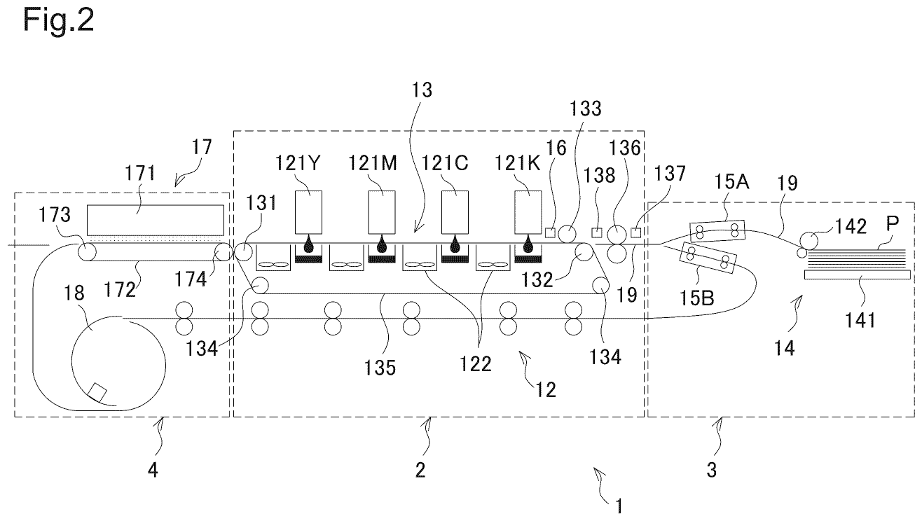

FIG. 2 is a schematic front cross-sectional view showing the image forming apparatus 1. The image forming apparatus 1 includes an apparatus main body 2 of the image forming apparatus 1, a sheet feeding unit 3, and a drying unit 4.

The sheet feeding unit 3 includes the sheet feeding device 14 and the skew correction mechanisms 15A and 15B. The sheet feeding device 14 includes a sheet cassette 141, a pickup roller 142 that draws out the recording sheet P from the sheet cassette 141 and feeds the recording sheet P toward the image forming device 12, and also a non-illustrated rotational drive mechanism for the pickup roller 142.

The skew correction mechanisms 15A and 15B are located upstream of the image forming device 12, in the transport direction. The skew correction mechanism 15A corrects the skew of the recording sheet P not yet turned over by the reversing mechanism 18. The skew correction mechanism 15B corrects the skew of the recording sheet P turned over by the reversing mechanism 18. The skew correction mechanisms 15A and 15B may hereinafter be collectively referred to as “skew correction mechanism 15”, where appropriate.

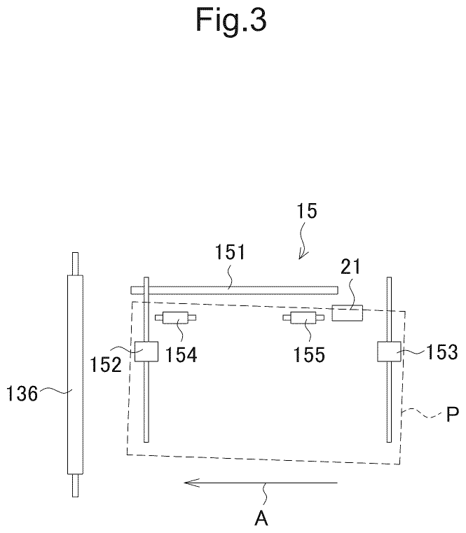

FIG. 3 is a schematic plan view showing the skew correction mechanism 15. The skew correction mechanism 15 includes an alignment plate 151 extending parallel to the transport direction A of the recording sheet P, and corrects the skew of the recording sheet P with respect to the transport direction A, by pressing the side edge of the recording sheet P extending along the transport direction A. against the alignment plate 151. After correcting the skew of the recording sheet P, the skew correction mechanism 15 transports the recording sheet P toward a resist roller pair 136 in the apparatus main body 2.

The skew correction mechanism 15 includes the alignment plate 151, a transport roller pair 152, 153 that makes pressure-contact with the recording sheet P, thereby feeding the recording sheet P in the transport direction A, a pressure roller pair 154, 155 that makes pressure-contact with the recording sheet P, thereby moving the recording sheet P in the width direction orthogonal to the transport direction A so as to abut the side edge of the recording sheet P against the alignment plate 151, and an inclination angle adjustment mechanism 21 that enables manual adjustment of the inclination angle of the alignment plate 151 with respect to the transport direction A. Further, the skew correction mechanism 51 includes rotational drive mechanisms (the drive source inclusive) for the transport roller pair 152, 153 and the pressure roller pair 154, 155, and pressing mechanisms that bring the respective roller pairs into contact with the recording sheet P, and move the roller pairs away therefrom.

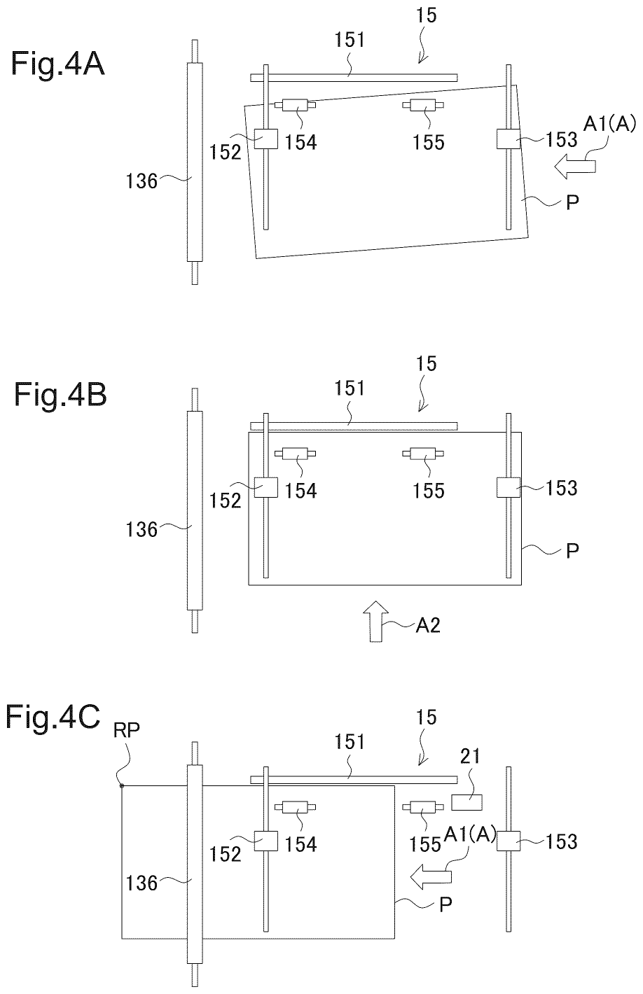

Referring now to FIG. 4A to FIG. 4C, description will be given hereunder on an operation of the controller 100 (see FIG. 1), performed to correct the skew of the recording sheet P with respect to the transport direction A, using the skew correction mechanism 15. The controller 100 controls the rotation of the transport roller pair 152, 153 in pressure-contact with the recording sheet P, so as to transport the recording sheet P in the direction indicated by a blank arrow Al (i.e., transport direction A) as shown in FIG. 4A. After the recording sheet P reaches the transport roller pair 152, the controller 100 stops the rotation of the transport roller pair 152, 153, and controls the operation of the pressing mechanism for the transport roller pair 152, 153, so as to release the recording sheet P from the pressure.

Then the controller 100 controls the operation of the pressing mechanism for the pressure roller pair 154, 155, so as to bring the pressure roller pair 154, 155, from the position spaced from the recording sheet P, into pressure-contact therewith. The controller 100 rotates the pressure roller pair 154, 155, thereby moving the recording sheet P in the direction indicated by a blank arrow A2, as shown in FIG. 4B. After the recording sheet P is abutted against the alignment plate 151, the controller 100 stops the rotation of the pressure roller pair 154, 155, and controls the operation of the pressing mechanism for the pressure roller pair 154, 155, so as to release the recording sheet P from the pressure of the pressure roller pair 154, 155.

When the recording sheet P is released from the pressure of the pressure roller pair 154, 155, the distortion of the recording sheet P, incurred because of being abutted against the alignment plate 151, is cancelled, so that the recording sheet P becomes aligned with the angle of the alignment plate 151. Thus the skew of the recording sheet P with respect to the transport direction A is corrected, and also the shift of the recording sheet P in the width direction orthogonal to the transport direction A (transverse shift) is corrected.

Thereafter, the controller 100 controls the operation of the pressing mechanism for the transport roller pair 152, 153, to bring the transport roller pair 152, 153 into pressure-contact with the recording sheet P, and rotates the transport roller pair 152, 153 so as to transport the recording sheet P in the direction indicated by the blank arrow Al, as shown in FIG. 4C. Here, the controller 100 defines one of the leading edge corners of the recording sheet P in the width direction orthogonal to the transport direction A (in this case, the leading edge corner on the side of the alignment plate 151), as an image forming reference position RP, and controls the operation of the image forming device 12, with the leading edge corner set as the reference, so as to execute the printing operation, by forming an image on the recording sheet P.

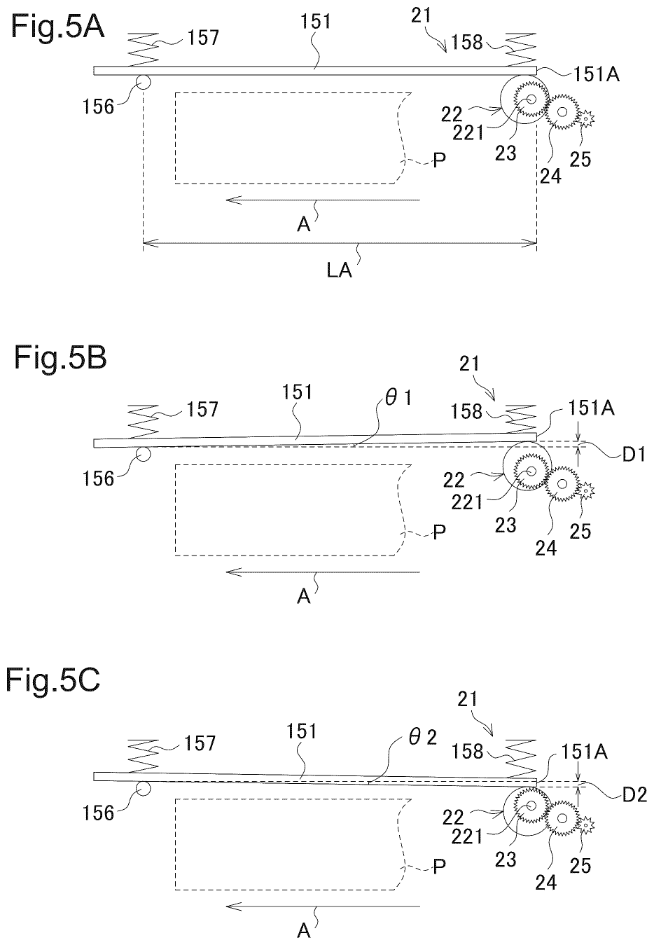

FIG. 5A to FIG. 5C are schematic plan views each showing the alignment plate 151 and the inclination angle adjustment mechanism 21. The inclination angle adjustment mechanism 21 includes a first gear 23, an eccentric cam 22 having a first gear 23 and configured to rotate about a rotation shaft 221, a second gear 24, and a third gear 25. The alignment plate 151 is biased clockwise in FIG. 5A about a pivotal shaft 156, by biasing members 157 and 158 (e.g., coil spring), so that the position (angle) of the alignment plate 151 varies by being pressed by the eccentric cam 22. A length LA refers to the length of the alignment plate 151 between the contact point between the alignment plate 151 and the pivotal shaft 156, and an end portion 151A distant from the contact point.

The first gear 23 of the eccentric cam 22 is linked with the third gear 25 via the second gear 24, and the third gear 25 is connected to a non-illustrated adjustment screw SC1 that can be manually operated. Accordingly, the eccentric cam 22 can be made to rotate by operating the adjustment screw SC1, so that the inclination angle of the alignment plate 151 can be adjusted.

FIG. 5B illustrates a state where the alignment plate 151 has been made to pivot counterclockwise in FIG. 5A by an angle 01, from the state shown in FIG. 5A, and the end portion 151A of the alignment plate 151 has moved by a distance D1, in the width direction orthogonal to the transport direction A. FIG. 5C illustrates a state where the alignment plate 151 has been made to pivot clockwise in FIG. 5A by an angle 02, from the state shown in FIG. 5A, and the end portion 151A of the alignment plate 151 has moved by a distance D2, in the width direction orthogonal to the transport direction A.

The third gear 25, connected to the adjustment screw SC1, has a fewer number of teeth than the first gear 23 and the second gear 24. Accordingly, the inclination angle of the alignment plate 151 can be minutely adjusted, by operating the adjustment screw SC1. Although the angle adjustment is to be performed steplessly, the influence of the meshing state between the gears is inevitable, and therefore an unfollowed phase may appear during the process of the angle adjustment, performed by repeatedly turning the adjustment screw SC1 to the left and the right. As result, an uncorrected amount may still remain.

The apparatus main body 2 shown in FIG. 2 includes the image forming device 12. The image forming device 12 includes ink heads 121K, 121C, 121M, and 121Y (hereinafter, collectively “ink head 121”, where appropriate) that respectively eject ink droplets of four colors, namely black, cyan, magenta, and yellow, a plurality of fans 122, a printing transport unit 13, and a detection device 16, and executes the printing operation, by forming an image on the recording sheet P delivered to the printing transport unit 13 from the sheet feeding device 14, through the transport route 19.

The fans 122 are for drying the ink stuck to the recording sheet P. The fans 122 are each located downstream of the corresponding ink head 121, in the transport direction.

The printing transport unit 13 includes a drive roller 131, a follower roller 132, an adsorption roller 133, a plurality of tension rollers 134, a transport belt 135, a resist roller pair 136, a resist sensor 137, and a sheet sensor 138.

The transport belt 135 is an endless belt stretched around the drive roller 131, the follower roller 132, and the tension roller 134, and transports the recording sheet P opposed to the ink head 121.

The drive roller 131 is driven by a non-illustrated roller driver, to rotate counterclockwise in FIG. 2. When the drive roller 131 is made to rotate, the transport belt 135 is made to revolve counterclockwise, and also the follower roller 132 and the tension rollers 134 are made to rotate counterclockwise.

The follower roller 132 also serves as a speed detection roller that detects the transport speed of the transport belt 135. A non-illustrated speed sensor that detects the rotation speed of the follower roller 132 is provided on the rotation shaft of the follower roller 132.

The tension roller 134, also called a meander correction roller, serves to maintain the tension of the transport belt 135 at an appropriate level. The adsorption roller 133 electrically charges the transport belt 135, so that the recording sheet P delivered from the sheet feeding device 14 is electrostatically adsorbed to the transport belt 135.

In the transport belt 135, a plurality of suction holes (not shown) are formed, and a non-illustrated negative pressure generator provided on the lower side of the transport belt 135 applies a negative pressure to the recording sheet P through the suction holes, thereby causing the recording sheet P to adsorb onto the transport belt 135.

The resist roller pair 136 is provided on the transport route 19 at a position upstream of the ink head 121, in the transport direction. The resist sensor 137 is located between the resist roller pair 136 and the sheet feeding device 14. The resist roller pair 136 temporarily detains the recording sheet P at the nip region defined thereby, and then again transport the recording sheet P to the position on which the ink is ejected from the ink head 121.

The resist sensor 137 is for adjusting the timing at which the recording sheet P is to be detained. The resist sensor 137 may be, for example, a known reflective photoelectric sensor including a light-emitting element and a photodetector that detects the light emitted from the light-emitting element and reflected by the recording sheet P, and serves to detect the leading edge of the recording sheet P.

The sheet sensor 138 is provided on the transport route 19 at a position between the resist roller pair 136 and the adsorption roller 133. The sheet sensor 138 is constituted of a reflective photoelectric sensor similar to the resist sensor 137, and serves to detect the leading edge and the trailing edge of the recording sheet P.

The detection device 16 is located upstream of the ink head 121 in the transport direction, and detects the shape (contour) of the recording sheet P that has undergone the skew correction by the skew correction mechanism 15, to thereby detect the leading edge corner of the recording sheet P in the transport direction, and the trailing edge corner on the same side as the leading edge corner. The detection device 16 may be, for example, a scanner such as a CIS. The detection device 16 extends in the width direction orthogonal to the transport direction of the recording sheet P, and has a length in the width direction sufficient to read the entirety of the recording sheet P. The detection device 16 reads the recording sheet P passing over the CIS, and acquires the image data representing the recording sheet P. The controller 100 (see FIG. 1) stores the image data representing the shape (contour) of the recording sheet P, detected by the detection device 16, in the storage device 8.

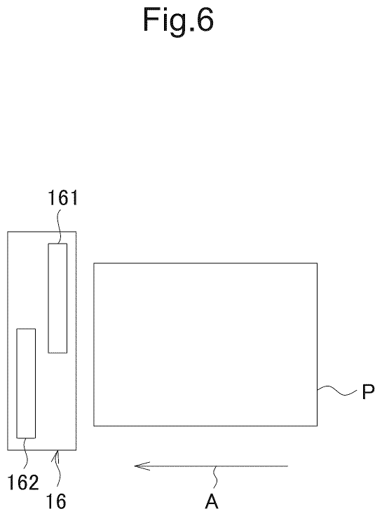

FIG. 6 is a plan view showing a location example of the CIS constituting the detection device 16, The detection device 16 includes two CISs 161 and 162, located at different positions in the transport direction A, so as to partially overlap in the width direction. Since a CIS having a wide reading range is expensive, a plurality of CISs having a shorter reading range, which are relatively inexpensive, are employed as shown in FIG. 6.

The drying unit 4 shown in FIG. 2 includes the drying device 17 and the reversing mechanism 18. The drying device 17 transports the recording sheet P, to dry the ink stuck to the recording sheet P. The drying device 17 includes a dryer 171, an endless transport belt 172, and a pair of rollers 173 and 174. The recording sheet P is dried by the dryer 171, while being transported by the transport belt 172 through the drying device 17, and transported to the position downstream of the drying device 17 in the transport direction. When the simplex printing is finished, or when the printing on the front and back faces are both finished in the duplex printing, the recording sheet P is transported to the left in FIG. 2 and delivered from a non-illustrated delivery port. When the back face is yet to be printed in the duplex printing, the recording sheet P is transported to the reversing mechanism 18.

The reversing mechanism 18 reverses the front face and the back face of the recording sheet P, on which an image has been formed by the image forming device 12, and causes the recording sheet P, the front and back faces of which have been reversed, to merge into the transport route 19, at the position upstream of the image forming position of the image forming device 12, in the transport direction of the recording sheet P. The recording sheet P, the front and back faces of which have been reversed by the reversing mechanism 18 enters the skew correction mechanism 15B, where the skew of the recording sheet P with respect to the transport direction is corrected.

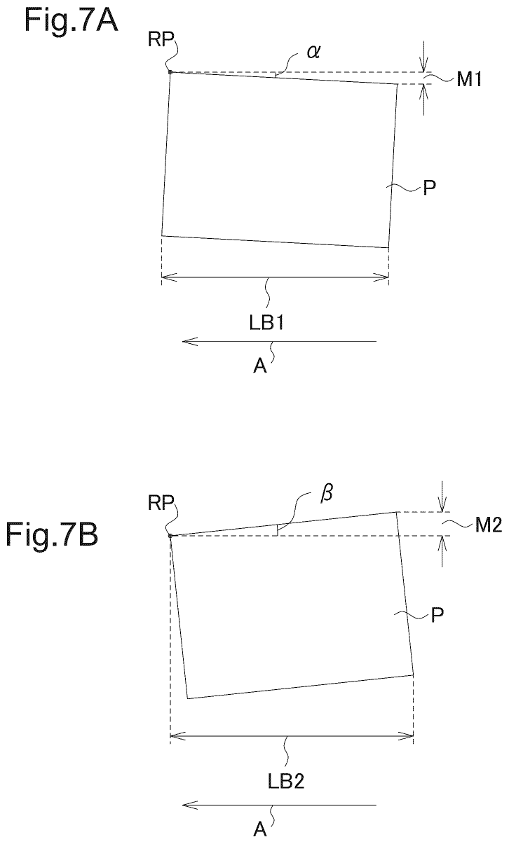

FIG. 7A and FIG. 7B are schematic drawings each showing an example of the posture of the recording sheet P, detected by the detection device 16. FIG. 7A illustrates an example of the posture of the recording sheet P, the front and back faces of which have not yet been reversed by the reversing mechanism 18. To be more specific, the recording sheet P is inclined clockwise in FIG. 7A about the image forming reference position RP (leading edge corner), by an angle a with respect to the transport direction A. FIG. 7B illustrates an example of the posture of the recording sheet P, the front and back faces of which have been reversed by the reversing mechanism 18. To be more specific, the recording sheet P is inclined counterclockwise in FIG. 7B about the image forming reference position RP, by an angle β with respect to the transport direction A.

In the ideal posture of the recording sheet P, the angles a and B should both be 0 degrees. However, even after the skew correction by the skew correction mechanism 15A or 15B, an uncorrected amount (deviation) may still remain, as shown in FIG. 7A and FIG. 7B.

A length LB1 shown in FIG. 7A indicates the length of the recording sheet P in the transport direction A, and a deviation amount MI corresponds to a distance in the width direction, between the leading edge corner of the recording sheet P in the transport direction A and the trailing edge corner on the same side as the leading edge corner. Here, the deviation amount MI has directionality, in other words the value of the deviation amount M1 may assume a positive and a negative value. Hereinafter, it will be defined that the deviation amount MI assumes a positive value when the recording sheet P is inclined clockwise about the image forming reference position RP, and assumes a negative value when the recording sheet P is inclined counterclockwise about the image forming reference position RP.

The deviation of the recording sheet P can be reduced by adjusting the inclination angle of the alignment plate 151. To cancel the skew of the recording sheet P by the angle α, the alignment plate 151 of the skew correction mechanism 15A has to be inclined in the direction opposite to the inclination direction of the recording sheet P (counterclockwise in FIG. 7A), by the same angle as the angle α. For example, when the angle a is equal to the angle θ1 (see FIG. 5B), the alignment plate 151 can be made to pivot by the angle α, by moving the alignment plate 151 in the width direction by the distance D1 (see FIG. 5B).

The ratio (proportional relation) between the length LA of the alignment plate 151 (see FIG. 5A) and the distance D1 accords with the ratio (proportional relation) between the length LB1 of the recording sheet P and the deviation amount M1. Therefore, an equation 1 “D1/LA=M1/LB1” is established, from which an equation 2 “distance D1=M1*(LA/LB1)” can be led.

To move the end portion 151A of the alignment plate 151 in the width direction (make the alignment plate 151 pivot), the adjustment screw SC1 is turned. The number of rotations R1 of the adjustment screw SC1, necessary for moving the end portion 151A of the alignment plate 151 by the distance D1, can be obtained from an equation 3 “R1=D1/X”. “X” is the travel distance of the end portion 151A, realized by one rotation of the adjustment screw SC1.

An equation 4 “R1=(M1/X)*(LA/LB1)” can be led from the equation 2 and the equation 3, and an equation 5 “R1=K*M1*(LA/LB1)” can be led, by setting the reciprocal of “X” as the coefficient K. The deviation amount M1 has directionality and assumes a positive and a negative value as described above, and therefore the number of rotations R1 also assumes a positive and a negative value. Accordingly, the rotating direction of the adjustment screw SC1 can be identified, from the number of rotations R1. The length LB1 of the recording sheet P can be obtained by multiplying the time after the sheet sensor 138 has detected the leading edge of the recording sheet P and until the sheet sensor 138 has detected the trailing edge thereof, by the transport speed of the transport belt 135. The transport speed of the transport belt 135 can be acquired from the speed sensor provided on the rotation shaft of the follower roller 132.

A length LB2 shown in FIG. 7B indicates the length of the recording sheet P in the transport direction A, and a deviation amount M2 corresponds to a distance in the width direction, between the leading edge corner of the recording sheet P in the transport direction A and the trailing edge corner on the same side as the leading edge corner. Here, the deviation amount M2 also has directionality, in other words the value of the deviation amount M2 may assume a positive and a negative value, and in this case the deviation amount M2 assumes a positive value.

As described above, the deviation of the recording sheet P can be reduced by adjusting the inclination angle of the alignment plate 151. To cancel the skew of the recording sheet P by the angle B, the alignment plate 151 of the skew correction mechanism 15B has to be appropriately inclined. However, the adjustment of the inclination angle of the alignment plate 151 of the skew correction mechanism 15B is not so simple as the adjustment of the inclination angle of the alignment plate 151 of the skew correction mechanism 15A.

This is because the angle β of the recording sheet P, the front and back faces of which have been reversed by the reversing mechanism 18, is influenced by the angle α of the recording sheet P, the front and back faces of which were yet to be reversed by the reversing mechanism 18. Therefore, in order to cancel the skew of the recording sheet P by the angle β, the alignment plate 151 of the skew correction mechanism 15B has to be inclined in the direction opposite to the inclination direction of the recording sheet P (clockwise in FIG. 7B), by the same angle as the angle (α+β). For example, when the angle (α+β) is equal to the angle θ2 (see FIG. 5C), the alignment plate 151 can be made to pivot by the angle (α+β), by moving the alignment plate 151 in the width direction by the distance D2 (see FIG. 5C).

When the recording sheet P is inclined by the angle (α+β), the deviation amount becomes (M1+M2), and since the proportional relation between the length LA of the alignment plate 151 (see FIG. 5A) and the distance D2 agrees with the proportional relation between the length LB2 of the recording sheet P and the deviation amount (M1+M2), an equation 6 “D2/LA=(M1+M2)/LB2” is established, from which an equation 7 “distance D2=(M1+M2)*(LA/LB2)” can be led.

To move the end portion 151A of the alignment plate 151 in the width direction (make the alignment plate 151 pivot), the adjustment screw SC1 is to be turned, and the number of rotations R2 of the adjustment screw SC1, necessary for moving the end portion 151A of the alignment plate 151 by the distance D2, can be obtained from an equation 8 “R2=D2/X”.

An equation 9 “R2=((M1+M2)/X)*LA/LB2)” can be led from the equation 7 and the equation 8, and an equation 10 “R2=K*(M1+M2)*(LA/LB2)” can be led, by setting the reciprocal of “X” as the coefficient K. The deviation amounts M1 and M2 each have directionality and assume a positive and a negative value as described above, and therefore the number of rotations R2 also assumes a positive and a negative value. Accordingly, the rotating direction of the adjustment screw SC1 can be identified, from the number of rotations R2. The length LB2 of the recording sheet P can also be obtained, like the length LB1, by multiplying the time after the sheet sensor 138 has detected the leading edge of the recording sheet P and until the sheet sensor 138 has detected the trailing edge thereof, by the transport speed of the transport belt 135.

Although the length LB2 of the recording sheet P may be regarded as being equal to the length LB1, the lengths LB1 and LB2 may differ from each other, owing to the drying operation for the recording sheet P. Therefore, it is preferable to calculate each of the lengths independently.

The calculator 101 shown in FIG. 1 calculates the distance in the width direction between the leading edge corner and the trailing edge corner of the recording sheet P, detected by the detection device 16, as the deviation amount of the recording sheet P, and also calculates the adjustment amount of the inclination angle of the alignment plate 151, necessary for reducing the deviation amount. To be more specific, the calculator 101 calculates the lengths LB1 and LB2 of the recording sheet P and the deviation amounts M1 and M2, and also calculates the number of rotations R1 and R2 of the adjustment screw SC1, using the equation 5 and the equation 10, as the adjustment amount of the inclination angle of the alignment plate 151.

When the skew of the recording sheet P is small, the skew can be corrected by adjusting the inclination angle of the alignment plate 151 of the skew correction mechanism 15. However, when the skew of the recording sheet P is not small, adjusting the inclination angle of the alignment plate 151 of the skew correction mechanism 15 is not sufficient for correcting the skew. In such a case, an adjustment screw SC2 of a joint mechanism 40, to be subsequently described, is manually operated, to adjust the sheet feeding angle on a horizontal plane, from the sheet feeding unit 3 to the apparatus main body 2.

The controller 100 notifies the adjustment amount of the inclination angle, calculated by the calculator 101, to the user. For example, the controller 100 controls the displaying operation of the display device 473, so as to display the number of rotations R1 and R2 of the adjustment screw SC1, on the display device 473. Here, the display device 473 exemplifies the notification device in CLAIMS, and “display” exemplifies the notification in CLAIMS.

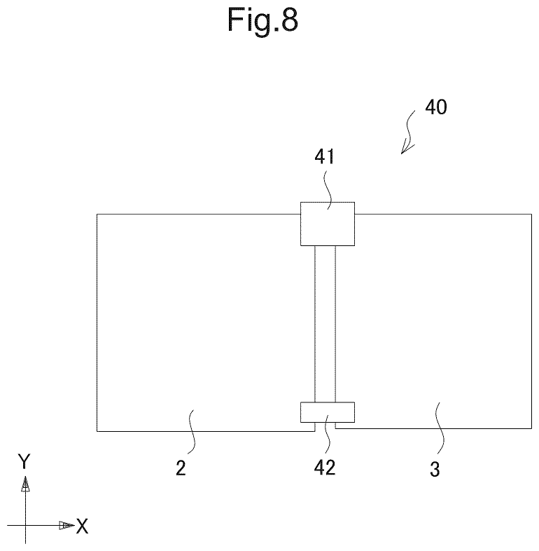

FIG. 8 is a schematic plan view showing the joint mechanism connecting the apparatus main body 2 and the sheet feeding unit 3. The joint mechanism 40 is connecting the apparatus main body 2 and the sheet feeding unit 3 in which the skew correction mechanism 15 is provided. The joint mechanism 40 includes a fulcrum device 41 located on the rear side, and a sheet angle adjustment mechanism 42 located on the front side, and configured to be manually operated to adjust the sheet feeding angle on the horizontal plane, from the sheet feeding unit 3 to the apparatus main body 2.

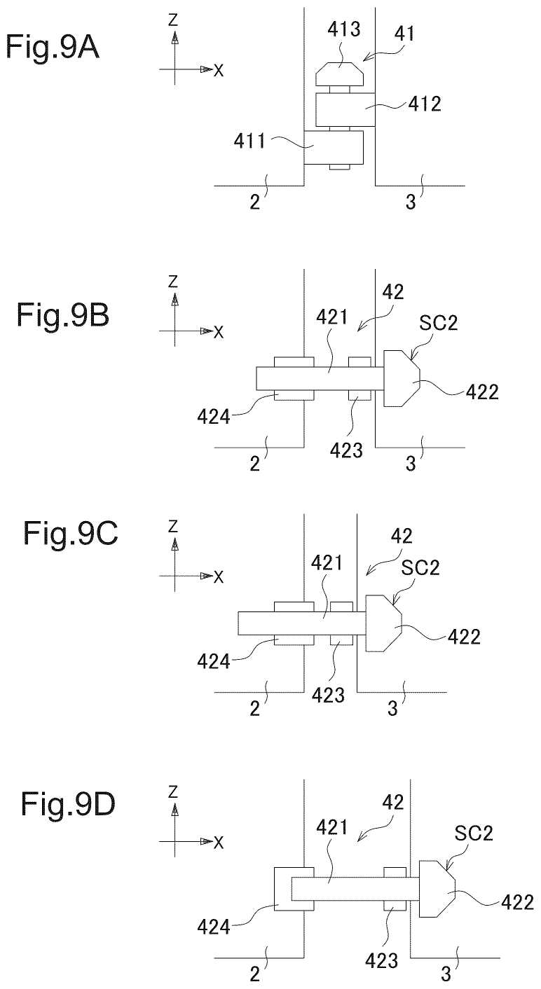

FIG. 9A is an enlarged front view schematically showing the fulcrum device 41. The fulcrum device 41 includes a joint bracket 411 protruding from the apparatus main body 2 toward the sheet feeding unit 3, a joint bracket 412 protruding from the sheet feeding unit 3 toward the apparatus main body 2, and a fulcrum pin 413 penetrating through support holes respectively formed in the joint brackets 411 and 412, so that the sheet feeding unit 3 can pivot about the fulcrum pin 413, with respect to the apparatus main body 2.

FIG. 9B to FIG. 9D are enlarged front views each showing the sheet angle adjustment mechanism 42. The sheet angle adjustment mechanism 42 includes a manually operable adjustment screw SC2 having a screw shaft 421, and a nut 424 fixed to the apparatus main body 2 to be engaged with the screw shaft 421. The adjustment screw SC2 includes a head 422 and a nut 423 fixed to the screw shaft 421. The head 422 is located inside the sheet feeding unit 3, and the nut 423 is located between the apparatus main body 2 and the sheet feeding unit 3.

When the adjustment screw SC2 is turned in the fastening direction, the distance between the apparatus main body 2 and the sheet feeding unit 3 is shortened as shown in FIG. 9C, and when the adjustment screw SC2 is turned in the loosening direction, the distance between the apparatus main body 2 and the sheet feeding unit 3 is prolonged as shown in FIG. 9D. Thus, the sheet feeding angle on the horizontal plane, from the sheet feeding unit 3 to the apparatus main body 2 can be adjusted, by operating the adjustment screw SC2.

As mentioned above, when the skew of the recording sheet P is not small, adjusting the inclination angle of the alignment plate 151 of the skew correction mechanism 15 is not sufficient for correcting the skew. Therefore, the sheet feeding angle on the horizontal plane, from the sheet feeding unit 3 to the apparatus main body 2, is also adjusted, by operating the adjustment screw SC2.

When the deviation amount M1, M2 calculated by the calculator 101 is equal to or larger than a predetermined threshold, the controller 100 notifies the user that the sheet feeding angle should be adjusted. For example, the controller 100 controls the display device 473 so as to display a message to the effect that the sheet feeding angle should be adjusted, on the display device 473.

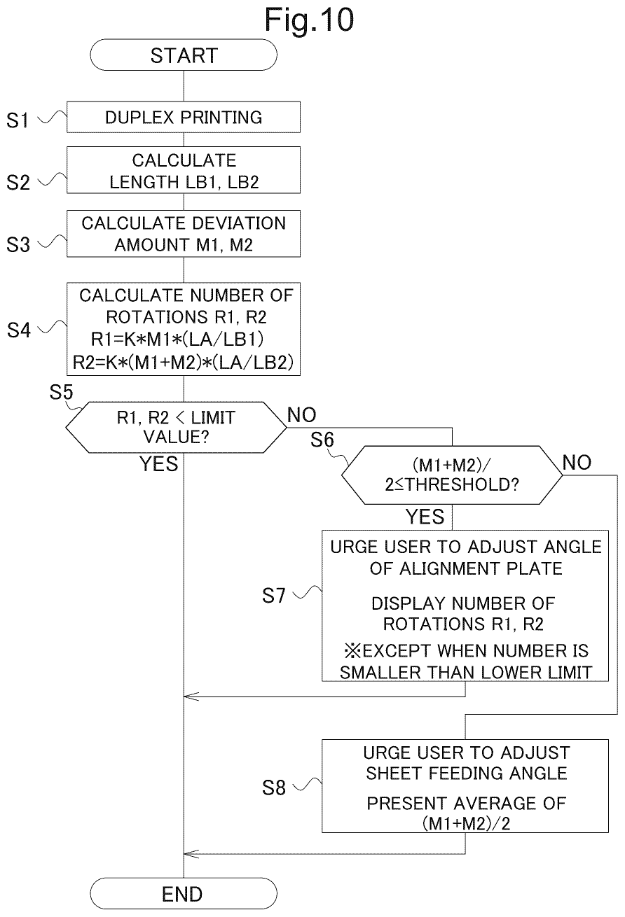

Referring now to a flowchart shown in FIG. 10, an operation performed by the image forming apparatus 1, to adjust the inclination angle of the alignment plate 151 of the skew correction mechanism 15, will be described hereunder. This operation is performed when the image forming apparatus 1 executes the duplex printing on the recording sheet P.

The controller 100 controls the operation of the image forming device 12, the sheet feeding device 14, the skew correction mechanism 15, and the reversing mechanism 18, to thereby execute the duplex printing, by forming an image on the front face and the back face of the recording sheet P (S1).

The calculator 101 calculates the lengths LB1 and LB2 of the recording sheet P, by multiplying the time after the leading edge of the recording sheet P passed the sheet sensor 138, and until the trailing edge thereof has passed the sheet sensor 138, by the transport speed of the transport belt 135 measured by the speed sensor provided on the follower roller 132 (S2).

The calculator 101 analyzes the image data on the recording sheet P, acquired by the detection device 16 at the time of printing on the front face and at the time of printing on the back face, to detect the respective positions of one of the leading edge corners, in the width direction orthogonal to the transport direction of the receding sheet P, and the trailing edge corner on the same side, before and after the front and back faces were reversed by the reversing mechanism 18, and calculates the deviation amounts M1 and M2 of the recording sheet P in the width direction, produced before and after the front and back faces were reversed by the reversing mechanism 18 (S3).

Then the calculator 101 calculates the adjustment amount (i.e., number of rotations R1 and R2) of the inclination angle of the alignment plate 151, necessary for reducing the deviation amounts M1 and M2, on the basis of the lengths LB1 and LB2, the deviation amounts M1 and M2, and the length LA of the alignment plate 151, using the equation 5 and the equation 10 (S4).

The controller 100 decides whether the numbers of rotations R1 and R2 are smaller than a predetermined lower limit (minimum operable value of the adjustment screw SC1, for adjusting the inclination angle of the alignment plate 151) (S5). Upon deciding that the numbers of rotations R1 and R2 are both smaller than the lower limit (YES at S5), the controller 100 finishes the operation. This is because, in such a case, it can be assumed that the respective alignment plates 151 of the skew correction mechanisms 15A and 15B are set to an appropriate inclination angle.

Upon deciding, in contrast, that at least one of the numbers of rotations R1 and R2 is not smaller than the lower limit (NO at S5), the controller 100 decides whether the average of the deviation amount M1 and the deviation amount M2 is equal to or lower than a predetermined threshold (S6).

Upon deciding that the average of the deviation amount Ml and the deviation amount M2 is equal to or lower than the threshold (YES at S6), the controller 100 causes the display device 473 to display a message urging the user to adjust the inclination angle of the alignment plate 151 of the skew correction mechanism 15, and information indicating the number of rotations R1 and R2 (S7). Thereafter, the controller 100 finishes the operation. However, when the number of rotations R1 or R2 is smaller than the lower limit, the controller 100 keeps from displaying the information thereof.

For example, the controller 100 controls the display device 473, so as to display the message urging the user to adjust the inclination angle of the alignment plate 151, and the numbers of rotations R1 and R2, for the respective adjustment screws SC1 of the skew correction mechanisms 15A and 15B, on the display device 473.

Since the numbers of rotations R1 and R2 may assume a positive or a negative value, when the number of rotations R1 is a positive value for example, the controller 100 displays the message to the effect that the adjustment screw SC1 of the skew correction mechanism 15A is to be turned counterclockwise by “R1” times. The user operates the respective adjustment screws SC1 of the skew correction mechanisms 15A and 15B according to the information displayed as above, thereby adjusting the inclination angle of the alignment plate 151. Because of such adjustment the deviation amounts M1 and M2 are reduced, and through the repetition of such adjustments, the skew of the recording sheet P with respect to the transport direction, or the transverse shift of the recording sheet P can be corrected.

Upon deciding that the average of the deviation amount M1 and the deviation amount M2 is not equal to or lower than the threshold (NO at S6), the controller 100 causes the display device 473 to display a message urging the user to adjust the sheet feeding angle on the horizontal plane, from the sheet feeding unit 3 to the apparatus main body 2 (i.e., rough adjustment prior to the mentioned fine adjustment), and information indicating the average of the deviation amount M1 and the deviation amount M2 (S8). Thereafter, the controller 100 finishes the operation. This is because, when the average of the deviation amount M1 and the deviation amount M2 is not equal to or lower than the threshold, the deviation amounts M1 and M2 are too large, and the skew of the recording sheet P with respect to the transport direction is unable to be corrected by such fine adjustment as adjusting the inclination angle of the alignment plate 151 of the skew correction mechanism 15.

For example, the controller 100 controls the display device 473, so as to display the message urging the user to adjust the joint angle between the apparatus main body 2 and the sheet feeding unit 3, and the average value of the deviation amount M1 and the deviation amount M2, which serves as an index for the rotation amount of the adjustment screw SC2, on the display device 473.

As another embodiment, the calculator 101 may calculate the adjustment amount of the sheet feeding angle necessary for reducing the deviation amounts M1 and M2, and the controller 100 may cause the display device 473 to display the message urging the user to adjust the sheet feeding angle, and the adjustment amount of the sheet feeding angle, calculated by the calculator 101. The adjustment amount of the sheet feeding angle can be calculated, on the basis of the average of the deviation amount M1 and the deviation amount M2, and a change in sheet feeding angle produced by one rotation of the adjustment screw SC2.

Through repeated adjustment of the sheet feeding angle, the deviation amounts M1 and M2 are reduced, such that the average of the deviation amount M1 and the deviation amount M2 falls below the threshold. Thereafter, the deviation amounts M1 and M2 are further reduced by adjusting the inclination angle of the alignment plate 151 of the skew correction mechanism 15, so that the skew of the recording sheet P with respect to the transport direction and the transverse shift are corrected.

The arrangement according to this embodiment also enables the positional shift in the width direction (transverse shift) of the recording sheet P to be reduced and corrected, in addition to the skew of the recording sheet P with respect to the transport direction A, corrected by the skew correction mechanism 15. In addition, the inclination angle of the alignment plate 151 of the skew correction mechanism 15 can be manually adjusted, and the amount of the manual adjustment is notified to the user. Therefore, the user can easily adjust the alignment plate 151 to an appropriate inclination angle. As result, the printing position on the front face and the back face of the recording sheet P can be precisely matched.

Further, not only the fine adjustment of the inclination angle of the alignment plate 151, but also the rough adjustment can be performed, by adjusting the sheet feeding angle on the horizontal plane from the sheet feeding unit 3 to the apparatus main body 2. Therefore, the adjustment can be performed over a wide range of deviation.

Now, there likely to be a case where the adjustment of the inclination angle of the alignment plate 151 of the skew correction mechanism 15, or the adjustment of the sheet feeding angle from the sheet feeding unit 3 fails to perfectly complete the adjustment, and an uncorrected amount (deviation) remains, so that the printing operation is executed with the recording sheet P remaining inclined.

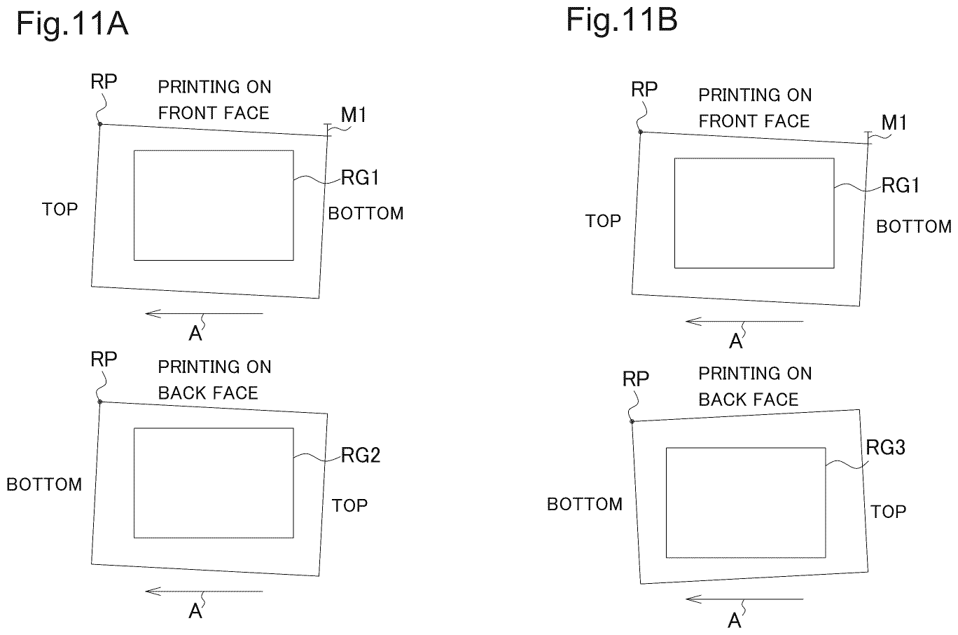

FIG. 11A and FIG. 11B are schematic drawings for explaining the image forming area, defined when an image is formed on the front face and the back face of the recording sheet P, with the recording sheet P kept inclined. FIG. 11A illustrates an image forming area RGI on the front face of the recording sheet P, and an image forming area RG2 on the back face of the recording sheet P, defined when the recording sheet P is inclined clockwise in FIG. 11A, about the image forming reference position RP. The deviation amount MI corresponds to the distance in the width direction orthogonal to the transport direction A, between one leading edge corner of the recording sheet P in the width direction and the trailing edge corner on the same side as the leading edge corner, defined at the time of the front face printing. At the time of the front face printing, the leading edge of the recording sheet P in the transport direction A corresponds to the top side of the image, while the leading edge of the recording sheet P corresponds to the bottom side of the image, at the time of the back face printing

FIG. 11B illustrates an image forming area RG1 on the front face of the recording sheet P defined when the recording sheet P is inclined clockwise in FIG. 11, about the image forming reference position RP, and an image forming area RG3 on the back face of the recording sheet P, defined when the recording sheet P is inclined counterclockwise in FIG. 11B.

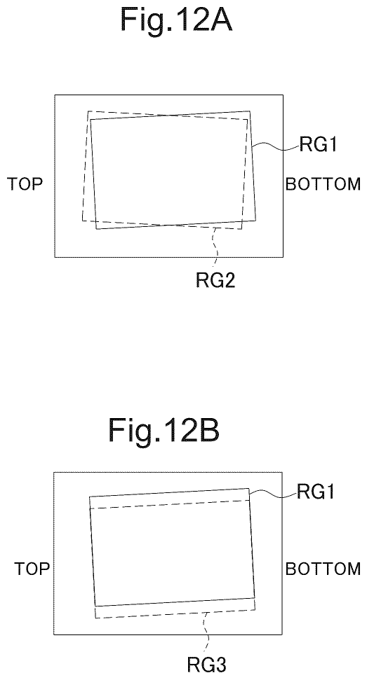

FIG. 12A and FIG. 12B are schematic drawings each showing the image forming area, seen from the side of the front face of the recording sheet P. FIG. 12A illustrates the image forming areas RG1 and RG2 shown in FIG. 11A, and FIG. 12B illustrates the image forming areas RG1 and RG3 shown in FIG. 11B. The image forming area RG1 is indicated by solid lines, and the image forming areas RG2 and RG3 are indicated by broken lines.

When the recording sheet P is inclined in the same direction, at the time of the front face printing and the back face printing, the image forming areas RG1 and RG2 are inclined in opposite directions as FIG. 12A. However, the positions of the respective image forming areas generally accord with each other.

On the other hand, when the recording sheet P is inclined in the opposite directions, at the time of the front face printing and the back face printing, although the image forming areas RG1 and RG2 are inclined in the same direction, the positions of the image forming areas may be largely deviated from each other, as shown in FIG. 12B.

Accordingly, as still another embodiment, when performing the printing operation on the back face of the recording sheet P, with the recording sheet P inclined in a different direction from the time of the front face printing, as shown in FIG. 11B, the controller 100 may move the image forming reference position RP in the direction opposite to the deviating direction of the deviation amount M1 of the recording sheet P, defined before the front and back faces were reversed by the reversing mechanism 18, by the same amount as the deviation amount M1. Such an arrangement prevents the image forming areas RG1 and RG3 from being largely deviated from each other, at the time of the front face printing and the back face printing.

According to an existing technique, different from the foregoing embodiment, the transverse shift of the recording sheet is corrected by moving a retention roller pair that transports the recording sheet pinched therebetween, and the skew is corrected by rotating the retention roller pair. However, the correction of the skew of the recording sheet by rotating the retention roller pair depends on the control resolution with respect to the roller, and therefore, in particular when the recording sheet is elongate in the transport direction, it is difficult to correct the skew with the mentioned technique. For example, when the size of the recording sheet in the width direction is 13 inches, and the length in the transport direction is 19.2 inches, and the rotation angle of the retention roller has an error of 0.1 degrees, a deviation (uncorrected amount) of approximately 1 mm is produced in the width direction, between the leading edge and the trailing edge of the recording sheet. In addition, when the transport speed of the recording sheet is fast, the skew correction of the recording sheet has to be completed in a short time. However, there is a certain limit to the improvement in precision of the control resolution, and therefore the deviation is inevitable, when the transport speed of the recording sheet is fast. Further, according to another example of the existing technique, the skew is corrected by abutting the leading edge of the recording sheet in the transport direction against a roller. However, such an arrangement is insufficient for completely correcting the transverse shift, and it is difficult to precisely match the printing positions on the front face and the back face of the recording sheet. With the arrangement according to the embodiment, in contrast, the printing positions on the front face and the back face of the recording sheet can be precisely matched.

The disclosure may be modified in various manners, without limitation to the configuration according to the foregoing embodiments. Further, the configurations and processings described in the embodiments with reference to FIG. 1 to FIG. 12B are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

What is claimed is:

1. An image forming apparatus comprising:
an image forming device that forms an image on a recording sheet;
a sheet feeding device that supplies the recording sheet to the image forming device;
a reversing mechanism that reverses a front face and a back face of the recording sheet, on which the image has been formed by the image forming device;
a skew correction mechanism including an alignment plate extending parallel to a transport direction of the recording sheet, and configured to correct a skew of the recording sheet with respect to the transport direction, by pressing a side of the recording sheet extending along the transport direction, against the alignment plate;
an inclination angle adjustment mechanism that adjusts an inclination angle of the alignment plate with respect to the transport direction;
a detection device that detects a leading edge corner, and a trailing edge corner on a same side as the leading edge corner, in the transport direction, of the recording sheet the skew of which has been corrected by the skew correction mechanism;
a control device including a processor, and configured to act, when the processor executes a control program, as:
a controller that executes duplex printing, including forming an image on the front face and the back face of the recording sheet, by controlling operation of the image forming device, the sheet feeding device, and the reversing mechanism;
a calculator that calculates a distance between the leading edge corner and the trailing edge corner in the width direction orthogonal to the transport direction, detected by the detection device, as a deviation amount of the recording sheet, and calculates an adjustment amount of the inclination angle that reduces the deviation amount; and
a notification device,
wherein the controller causes the notification device to notify the adjustment amount of the inclination angle, calculated by the calculator, and
the skew correction mechanism is located on an upstream side of the image forming device, in the transport direction.

2. The image forming apparatus according to claim 1,
wherein the controller is configured to:
cause the notification device to notify the adjustment amount of the inclination angle, when the adjustment amount of the inclination angle calculated by the calculator is equal to or larger than a minimum value of the inclination angle that can be adjusted by the inclination angle adjustment mechanism; and
keep from causing the notification device to notify the adjustment amount of the inclination angle, when the adjustment amount of the inclination angle calculated by the calculator is smaller than the minimum value of the inclination angle that can be adjusted by the inclination angle adjustment mechanism.

3. The image forming apparatus according to claim 1,
wherein the skew correction mechanism is located at a position between the sheet feeding device and the image forming device, and at a position upstream of the image forming device in the transport direction, on a transport route on which the recording sheet, the front face and the back face of which have been reversed by the reversing mechanism, is transported.

4. The image forming apparatus according to claim 1,
wherein the skew correction mechanism includes a pressure roller pair that makes pressure-contact with the recording sheet and move the recording sheet in the width direction, thereby abutting a side of the recording sheet against the alignment plate.

5. The image forming apparatus according to claim 1, further comprising a joint mechanism that connects an apparatus main body including the image forming device, and the sheet feeding device including the skew correction mechanism,
wherein the joint mechanism includes a sheet angle adjustment mechanism that adjusts a sheet feeding angle on a horizontal plane, from the sheet feeding device to the apparatus main body, and
the controller causes the notification device to notify a message urging a user to adjust the sheet feeding angle, when the deviation amount is not equal to or smaller than a predetermined threshold.

6. The image forming apparatus according to claim 4,
wherein the calculator calculates the adjustment amount of the sheet feeding angle for reducing the deviation amount, and
the controller causes the notification device to notify a message including the adjustment amount of the sheet feeding angle calculated by the calculator, and urging a user to adjust the sheet feeding angle.

7. The image forming apparatus according to claim 1,
wherein the controller defines one of leading edge corners of the recording sheet in the width direction as an image forming reference position, and executes a printing operation by controlling the image forming device so as to form an image on the recording sheet, using the leading edge corner as reference position.

8. The image forming apparatus according to claim 7,
wherein, in a case of executing the printing operation on the back face of the recording sheet, when the recording sheet is inclined in a different direction from a direction in the printing operation on the front face, the controller moves the image forming reference position, in a direction opposite to a direction of the deviation amount of the recording sheet, produced before the front face and the back face were reversed by the reversing mechanism, by an amount corresponding to the deviation amount.
